(19) United States
(12) Patent Application Publication
(10) Pub. No.: US 2023/0125257 A1
(43) Pub. Date: Apr. 27, 2023

(54) LOW GWP HEAT TRANSFER COMPOSITIONS

(71) Applicant: HONEYWELL INTERNATIONAL INC., Charlotte, NC (US)

(72) Inventors: Ryan Hulse, Charlotte, NC (US); Ronald Vogl, Charlotte, NC (US); Kyle Cuellar, Charlotte, NC (US); Oluwaseyi Kayode, Charlotte, NC (US)

(73) Assignee: HONEYWELL INTERNATIONAL INC., Charlotte, NC (US)

(21) Appl. No.: 17/971,353

(22) Filed: Oct. 21, 2022

Related U.S. Application Data
(60) Provisional application No. 63/271,069, filed on Oct. 22, 2021.

(51) Int. Cl. C09K 5/04

(52) U.S. Cl. CPC C09K 5/045; C09K 2205/126

(57) ABSTRACT

Refrigerants comprising from about 40% to about 60% by weight carbon dioxide (CO2), from about 30% to about 45% by weight of trans-1,3,3,3-tetrafluoropropene (HFO-1234ze(E)), and from 2.0% to about 15% by weight of trans-1-chloro-3,3,3-trifluoropropene (HFCO-1233zd(E).

### CROSS REFERENCE TO RELATED APPLICATION

The present application claims the priority benefit of U.S. Provisional Application No. 63/271,069, filed on Oct. 22, 2021, which is incorporated herein by reference in its entirety.

### FIELD OF THE INVENTION

This invention relates to compositions, methods and systems having utility in refrigeration applications, and in certain particular aspects to heat transfer and/or refrigerant compositions useful in low temperature cooling applications, including cryogenic refrigeration applications.

### BACKGROUND

Fluorocarbon based fluids have found widespread use in many commercial and industrial applications, including as the working fluid in systems such as air conditioning, heat pump and refrigeration systems, among other uses such as aerosol propellants, as blowing agents, and as gaseous dielectrics.

Heat transfer fluids, to be commercially viable, must satisfy certain very specific and in certain cases very stringent combinations of physical, chemical and economic properties. Moreover, there are many different types of heat transfer systems and heat transfer equipment, and in many cases it is important that the heat transfer fluid used in such systems possess a particular combination of properties that match the needs of the individual system. For example, systems based on the vapor compression cycle usually involve the phase change of the refrigerant from the liquid to the vapor phase through heat absorption at a relatively low pressure and compressing the vapor to a relatively elevated pressure, condensing the vapor to the liquid phase through heat removal at this relatively elevated pressure and temperature, and then reducing the pressure to start the cycle over again.

Certain hydrocarbons and fluorocarbons, for example, have been a preferred component in many heat exchange fluids for many years in many applications. For example, both propane and 1,1,12-tetrafluoroehtane (HFC-134a) have been used in cryogenic refrigeration processes to achieve cooling at very low temperatures, for example, temperatures at or below −30° C. (See for example, US 2010/0281915, which discloses the use of mixed refrigerants comprising propane and HFCs to produce liquified natural gas). However, the use of each of these refrigerants has potential drawbacks. In particular, propane is a flammable fluid, which can be an obvious disadvantage.

With respect to HFC-134a, a concern surrounding this hydrofluorocarbon (HFC) refrigerant and many other saturated HFC refrigerants is the tendency of many such products to cause global warming. This characteristic is commonly measured as global warming potential (GWP). The GWP of a compound is a measure of the potential contribution to the green house effect of the chemical against a known reference molecule, namely, CO₂ which has a GWP=1. For example, the following known refrigerants possess the following Global Warming Potentials:

| REFRIGERANT | GWP (IPCC AR5) |
|---|---|
| R410A | 2088 |
| R-507 | 3985 |
| R404A | 3943 |
| R407C | 1774 |
| R-134a | 1300 |

While each of the above-noted refrigerants has proven effective in many respects, these materials are become increasingly less preferred since it is frequently undesirable to use materials having relatively high GWP. A need exists, therefore, for substitutes for these and other existing refrigerants having undesirable GWPs in refrigeration application, including in low-temperature and cryogenic refrigeration applications.

With respect to performance properties, the present applicants have come to appreciate that that any potential substitute refrigerant must also possess those properties present in many of the most widely used fluids, such as excellent heat transfer properties, chemical stability, low- or no-toxicity, low or non-flammability and lubricant compatibility, among others.

With regard to efficiency in use, it is important to note that a loss in refrigerant thermodynamic performance or energy efficiency may have secondary environmental impacts through increased fossil fuel usage arising from an increased demand for electrical energy.

With regard to flammability, it is considered either important or essential in many heat transfer applications to use compositions which are non-flammable or of relatively low flammability. As used herein, the term “non-flammable” refers to compounds or compositions which are determined to be non-flammable as determined in accordance with ASTM standard E-681, dated 2002, which is incorporated herein by reference. Unfortunately, many HFC's which might otherwise be desirable for used in refrigerant compositions are highly flammable. For example, the fluoroalkane difluoroethane (HFC-152a) is flammable and therefore not viable for use alone in many applications.

The difficulty of achieving a low-temperature refrigerant (e.g., refrigerant for cryogenic separation) capable of at once achieving many or all of the above-noted properties is illustrated, for example, by the refrigerants disclosed in US 2019/0309202 (the '202 Application). In particular, the '202 Application discloses the use of a mixed refrigerant blend comprising at least five different components (and one optional component) in a process to achieve cryogenic temperatures. These components are: (1) nitrogen or argon; (2—optional) methane or krypton; (3) tetrafluormethane; (4) trifluoromethane or fluoromethane; (5) at least one of 2,3,3,3-tetrafluoro-1-propene, hexafluoropropylene, pentafluoropropene, and 1,3,3,3-tetrafluoro propene; and (6) at least one of 1,1,1,3,3-pentafluoropropane, 1,1,2,2,3-pentafluoropropane, monochloro-trifluoropropene, and hexafluoro-2-butene. Among other possible disadvantages, the refrigerant blend as disclosed in the '202 Application can be undesirable simply because of the complexity of using a blend with five or more separate components in a refrigerant blend, including the possibility of having an undesirably large evaporator glide.

Applicants have thus come to appreciate a need for refrigerants and heat transfer compositions, and for heat transfer methods and systems, that are particularly useful in low temperature refrigeration applications, while preferably avoiding one or more of the disadvantages noted above.

### SUMMARY

Applicants have found that the compositions of the present invention satisfy, in an exceptional and unexpected way, the need for sub-150 GWP alternatives and/or replacements for previously used refrigerants, including particularly low-temperature and cryogenic refrigerants, that are at once of low flammability (e.g., are only mildly flammable (i.e., have a 2L classification according to ANSI/ASHRAE 34-2019, Designation and Safety Classification of Refrigerants, or more preferably are non-flammable according to ASTM E-681 and 23° C. (i.e., Class 1), non-toxic fluids (and most preferably Class A1) that have excellent heat transfer performance properties and also preferably have a glide that is not excessively high. As used herein, the term “sub-150 GWP” is used for convenience to refer to refrigerants which have a GWP (measured as described hereinafter) of 150 or less.

The present invention includes refrigerants comprising at least about 98.5% by weight of the following three compounds, with each compound being present in the following relative percentages:

about 40% to about 60% by weight carbon dioxide (CO₂);

about 30% to about 45% by weight of trans-1,3,3,3-tetrafluoropropene (HFO-1234ze(E)); and

2.0% to about 15% by weight of trans-1-chloro-3,3,3-trifluoropropene (HFCO-1233zd(E). Refrigerants as described in this paragraph are sometimes referred to for convenience as Refrigerant 1.

The present invention also includes refrigerants comprising at least about 98.5% by weight of the following three compounds, with each compound being present in the following relative percentages:

about 50% to about 60% by weight CO₂;

about 35% to about 45% by weight of HFO-1234ze(E); and

about 5% to about 10% by weight of HFCO-1233zd(E). Refrigerants as described in this paragraph are sometimes referred to for convenience as Refrigerant 2.

The present invention also includes refrigerants comprising at least about 98.5% by weight of the following three compounds, with each compound being present in the following relative percentages:

about 50% to about 55% by weight CO₂;

about 35% to about 40% by weight of HFO-1234ze(E); and

about 5% to about 10% by weight of HFCO-1233zd(E). Refrigerants as described in this paragraph are sometimes referred to for convenience as Refrigerant 3.

The present invention also includes refrigerants comprising at least about 98.5% by weight of the following three compounds, with each compound being present in the following relative percentages:

about 54% by weight CO₂;

about 38% by weight of HFO-1234ze(E); and

about 8% by weight of HFCO-1233zd(E). Refrigerants as described in this paragraph are sometimes referred to for convenience as Refrigerant 4.

The present invention also includes refrigerants comprising at least about 98.5% by weight of the following three compounds, with each compound being present in the following relative percentages:

54%+/−1% by weight CO₂;

38%+/−1% by weight of HFO-1234ze(E); and

8%+/−1% by weight of HFCO-1233zd(E). Refrigerants as described in this paragraph are sometimes referred to for convenience as Refrigerant 5.

The present invention includes refrigerants consisting essentially of the following three compounds, with each compound being present in the following relative percentages:

about 40% to about 60% by weight CO₂;

about 30% to about 45% by weight of HFO-1234ze(E); and

2.0% to about 15% by weight of HFCO-1233zd(E). Refrigerants as described in this paragraph are sometimes referred to for convenience as Refrigerant 6.

The present invention also includes refrigerants consisting essentially of the following three compounds, with each compound being present in the following relative percentages:

about 50% to about 60% by weight CO₂;

about 35% to about 45% by weight of HFO-1234ze(E); and

about 5% to about 10% by weight of HFCO-1233zd(E). Refrigerants as described in this paragraph are sometimes referred to for convenience as Refrigerant 7.

The present invention also includes refrigerants consisting essentially of the following three compounds, with each compound being present in the following relative percentages:

about 50% to about 55% by weight CO₂;

about 35% to about 40% by weight of HFO-1234ze(E); and

about 5% to about 10% by weight of HFCO-1233zd(E). Refrigerants as described in this paragraph are sometimes referred to for convenience as Refrigerant 8.

The present invention also includes refrigerants consisting essentially of the following three compounds, with each compound being present in the following relative percentages:

about 54% by weight CO₂;

about 38% by weight of HFO-1234ze(E); and

about 8% by weight of HFCO-1233zd(E). Refrigerants as described in this paragraph are sometimes referred to for convenience as Refrigerant 9.

The present invention also includes refrigerants consisting essentially of the following three compounds, with each compound being present in the following relative percentages:

54%+/−1% by weight CO₂;

38%+/−1% by weight of HFO-1234ze(E); and

8%+/−1% by weight of HFCO-1233zd(E). Refrigerants as described in this paragraph are sometimes referred to for convenience as Refrigerant 10.

The present invention includes refrigerants consisting of the following three compounds, with each compound being present in the following relative percentages:

about 40% to about 60% by weight CO₂;

about 30% to about 45% by weight of trans-1,3,3,3-tetrafluoropropene (HFO-1234ze(E)); and

2.0% to about 15% by weight of trans-1-chloro-3,3,3-trifluoropropene (HFCO-1233zd(E). Refrigerants as described in this paragraph are sometimes referred to for convenience as Refrigerant 11.

The present invention also includes refrigerants consisting of the following three compounds, with each compound being present in the following relative percentages:

about 50% to about 60% by weight CO₂;

about 35% to about 45% by weight of HFO-1234ze(E); and

about 5% to about 10% by weight of HFCO-1233zd(E). Refrigerants as described in this paragraph are sometimes referred to for convenience as Refrigerant 12.

The present invention also includes refrigerants consisting of the following three compounds, with each compound being present in the following relative percentages:

about 50% to about 55% by weight CO₂;

about 35% to about 40% by weight of HFO-1234ze(E); and

about 5% to about 10% by weight of HFCO-1233zd(E). Refrigerants as described in this paragraph are sometimes referred to for convenience as Refrigerant 13.

The present invention also includes refrigerants consisting of the following three compounds, with each compound being present in the following relative percentages:

about 54% by weight CO₂;

about 38% by weight of HFO-1234ze(E); and

about 8% by weight of HFCO-1233zd(E). Refrigerants as described in this paragraph are sometimes referred to for convenience as Refrigerant 14.

The present invention also includes refrigerants consisting of the following three compounds, with each compound being present in the following relative percentages:

54%+/−1% by weight CO₂;

38%+/−1% by weight of HFO-1234ze(E); and

8%+/−1% by weight of HFCO-1233zd(E). Refrigerants as described in this paragraph are sometimes referred to for convenience as Refrigerant 15.

### BRIEF DESCRIPTION OF THE DRAWINGS

FIG. 1 is a process flow illustration of one embodiment of a CO₂ recovery system using a dual refrigerant fractionation process and which uses a refrigerant according to the present invention.

FIG. 2 is a process flow illustration of one embodiment of a CO₂ recovery system using a mixed refrigerant fractionation process and which uses a refrigerant according to the present invention.

FIG. 3 is a schematic representation of an exemplary heat transfer system useful in refrigeration applications.

### DETAILED DESCRIPTION OF THE INVENTION

### Definitions

For the purposes of this invention, the term “about” in relation to the amounts expressed in weight percent means that the amount of the component can vary by an amount of +/−2% by weight.

For the purposes of this invention, the term “about” in relation to temperatures in degrees centigrade (° C.) means that the stated temperature can vary by an amount of +/−5° C.

The term “capacity” is the amount of cooling provided, in BTUs/hr, by the refrigerant in the refrigeration system. This is experimentally determined by multiplying the change in enthalpy in BTU/lb, of the refrigerant as it passes through the evaporator by the mass flow rate of the refrigerant. The enthalpy can be determined from the measurement of the pressure and temperature of the refrigerant. The capacity of the refrigeration system relates to the ability to maintain an area to be cooled at a specific temperature. The capacity of a refrigerant represents the amount of cooling or heating that it provides and provides some measure of the capability of a compressor to pump quantities of heat for a given volumetric flow rate of refrigerant. In other words, given a specific compressor, a refrigerant with a higher capacity will deliver more cooling or heating power.

The phrase “coefficient of performance” (hereinafter “COP”) is a universally accepted measure of refrigerant performance, especially useful in representing the relative thermodynamic efficiency of a refrigerant in a specific heating or cooling cycle involving evaporation or condensation of the refrigerant. In refrigeration engineering, this term expresses the ratio of useful refrigeration or cooling capacity to the energy applied by the compressor in compressing the vapor and therefore expresses the capability of a given compressor to pump quantities of heat for a given volumetric flow rate of a heat transfer fluid, such as a refrigerant. In other words, given a specific compressor, a refrigerant with a higher COP will deliver more cooling or heating power. One means for estimating COP of a refrigerant at specific operating conditions is from the thermodynamic properties of the refrigerant using standard refrigeration cycle analysis techniques (see for example, R. C. Downing, FLUOROCARBON REFRIGERANTS HANDBOOK, Chapter 3, Prentice-Hall, 1988 which is incorporated herein by reference in its entirety).

The phrase “discharge temperature” refers to the temperature of the refrigerant at the outlet of the compressor. The advantage of a low discharge temperature is that it permits the use of existing equipment without activation of the thermal protection aspects of the system which are preferably designed to protect compressor components and avoids the use of costly controls such as liquid injection to reduce discharge temperature.

The phrase “Global Warming Potential” (hereinafter “GWP”) was developed to allow comparisons of the global warming impact of different gases. Specifically, it is a measure of how much energy the emission of one ton of a gas will absorb over a given period of time, relative to the emission of one ton of carbon dioxide. The larger the GWP, the more that a given gas warms the Earth compared to CO2 over that time period. The time period usually used for GWP is 100 years. GWP provides a common measure, which allows analysts to add up emission estimates of different gases. See http://www.protocolodemontreal.org.br/site/images/publicacoes/setor_manufatura_equipamentos_refrigeracao_arcondicionado/Como_calcular_el_Potencial_de_Calentamiento_Atmosferico_en_las_mezclas_de_re frigerantes.pdf

The term “Occupational Exposure Limit (OEL)” is determined in accordance with ASHRAE Standard 34-2016 Designation and Safety Classification of Refrigerants.

The term “mass flow rate” is the mass of refrigerant passing through a conduit per unit of time.

The phrase “thermodynamic glide” applies to zeotropic refrigerant mixtures that have varying temperatures during phase change processes in the evaporator or condenser at constant pressure.

The term “low temperature refrigeration” refers to heat transfer systems and methods which operate with the refrigerant evaporating at a temperature of from about −45° C. and up to and about ambient.

The term “cryogenic refrigeration” refers to heat transfer systems and methods which operate with the refrigerant evaporating at a temperature of less than about −45° C.

### Refrigerants and Heat Transfer Compositions

Applicants have found that the refrigerants of the present invention, including each of Refrigerants 1-15 as described herein, is capable of providing one or more exceptionally advantageous properties including: heat transfer properties, low or no toxicity, mild flammability (Class 2L) and more preferably non-flammability (Class 1), near zero ozone depletion potential (“ODP”), and lubricant compatibility, including acceptable miscibility with POE and/or PVE lubricants including preferably over the operating temperature range of the refrigerant in low-temperature and cryogenic refrigeration.

Applicants have found that the refrigerant compositions of the invention, including each of Refrigerants 1-15, are capable of achieving a difficult to achieve combination of properties including particularly low GWP. Thus, the compositions of the invention have a GWP of 150 or less and preferably 75 or less.

In addition, the refrigerant compositions of the invention, including each of Refrigerants 1-15, have a low ODP. Thus, the compositions of the invention have an ODP of not greater than 0.05, preferably not greater than 0.02, and more preferably about zero.

In addition, the refrigerant compositions of the invention, including each of Refrigerants 1-15, show acceptable toxicity and preferably have an OEL of greater than about 400. As those skilled in the art are aware, a non-flammable refrigerant that has an OEL of greater than about 400 is advantageous since it results in the refrigerant being classified in the desirable Class 1A of ASHRAE standard 34.

Applicants have found that the heat transfer compositions of the present invention, including heat transfer compositions that include each of Refrigerants 1-15 as described herein, is capable of providing an exceptionally advantageous and unexpected combination of properties including: heat transfer properties, chemical stability under the conditions of use, low or no toxicity, mild-flammability or non-flammability, near zero ozone depletion potential (“ODP”), sub-150 GWP, and acceptable lubricant compatibility, including acceptable miscibility with POE and/or PVE lubricants.

The heat transfer compositions can consist essentially of any refrigerant of the present invention, including each of Refrigerants 1-15.

The heat transfer compositions of the present invention can consist of any refrigerant of the present invention, including each of Refrigerants 1-15.

The heat transfer compositions of the invention may include other components for the purpose of enhancing or providing certain functionality to the compositions. Such other components may include, in addition to the refrigerant of the present invention, including each of Refrigerants 1-15, one or more of lubricants, passivators, flammability suppressants, dyes, solubilizing agents, compatibilizers, stabilizers, antioxidants, corrosion inhibitors, extreme pressure additives and anti-wear additives and other compounds and/or components that modulate a particular property of the heat transfer composition, and the presence of all such compounds and components is within the broad scope of the invention.

Lubricants

The heat transfer composition of the invention particularly comprises a refrigerant as described herein, including each of Refrigerants 1-15, and a lubricant. Applicants have found that the heat transfer compositions of the present invention, including heat transfer compositions that include a lubricant, and particularly a POE and/or PVE lubricant and each of Refrigerants 1-15 as described herein, is capable of providing exceptionally advantageous properties including, in addition to the advantageous properties identified herein with respect to the refrigerant, excellent refrigerant/lubricant compatibility, including acceptable miscibility with POE and/or PVE lubricants over the operating temperature and concentration ranges for the intended use, including particularly low-temperature refrigeration and cryogenic refrigeration.

Commonly used refrigerant lubricants such as polyol esters (POEs), polyalkylene glycols (PAGs), PAG oils, silicone oils, mineral oil, alkylbenzenes (ABs), polyvinyl ethers (PVEs), polyethers (PEs) and poly(alpha-olefin) (PAO) that are used in refrigeration machinery may be used with the refrigerant compositions of the present invention.

Preferably the lubricants are selected from PAGs, POEs, and PVE.

Preferably the lubricants comprise POEs.

Preferably the lubricants comprise PVEs.

Preferably the lubricants comprise PAGs.

In general, the heat transfer compositions of the present invention that include POE lubricant comprise POE lubricant in amounts preferably of from about 0.1% by weight to about 5%, or from 0.1% by weight to about 1% by weight, or from 0.1% by weight to about 0.5% by weight, based on the weight of the heat transfer composition.

Commercially available POEs that are preferred for use in the present heat transfer compositions include neopentyl glycol dipelargonate which is available as Emery 2917 (registered trademark) and Hatcol 2370 (registered trademark) and pentaerythritol derivatives including those sold under the trade designations Emkarate RL32-3MAF and Emkarate RL68H by CPI Fluid Engineering. Emkarate RL32-3MAF and Emkarate RL68H are preferred POE lubricants having the properties identified below:

| | RL32- | |
|---|---|---|
| Property | 3MAF | RL68H |
| Viscosity | about 31 | about 67 |
| @ 40° C. (ASTM D445), cSt | | |
| Viscosity | about 5.6 | about 9.4 |
| @ 100° C. (ASTM D445), cSt | | |
| Pour Point | about −40 | about −40 |
| (ASTM D97), ° C. | | |

In general, the heat transfer compositions of the present invention that include PVE lubricant comprise PVE lubricant in amounts preferably of from about 0.1% by weight to about 5%, or from 0.1% by weight to about 1% by weight, or from 0.1% by weight to about 0.5% by weight, based on the weight of the heat transfer composition.

Commercially available polyvinyl ethers that are preferred for use in the present heat transfer compositions include those lubricants sold under the trade designations FVC32D and FVC68D, from Idemitsu.

Commercially available PAG lubricants are preferred for use in the present heat transfer compositions include those lubricants sold under the trade designations Nippon-Denso ND oil-8, ND oil-12; Idemitsu PS-D1; Sanden SP-10.

Other additives not mentioned herein can also be included by those skilled in the art in view of the teaching contained herein without departing from the novel and basic features of the present invention.

### Methods, Uses and Systems

The refrigerants, including Refrigerants 1-15, and heat transfer compositions as disclosed herein, are provided for use in heat transfer applications, including low-temperature refrigeration and cryogenic refrigeration.

For heat transfer systems of the present invention that include a compressor and lubricant for the compressor in the system, the system can comprises a loading of refrigerant and lubricant such that the lubricant loading in the system is from about 5% to 60% by weight, or from about 10% to about 60% by weight, or from about 20% to about 50% by weight, or from about 20% to about 40% by weight, or from about 20% to about 30% by weight, or from about 30% to about 50% by weight, or from about 30% to about 40% by weight. As used herein, the term “lubricant loading” refers to the total weight of lubricant contained in the system as a percentage of total of lubricant and refrigerant contained in the system. Such systems may also include a lubricant loading of from about 5% to about 10% by weight, or about 8% by weight of the heat transfer composition.

Exemplary Heat Transfer Systems

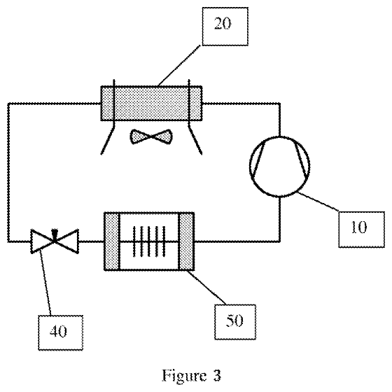

As described in more detail below, the preferred systems of the present invention comprise a compressor, a condenser, an expansion device and an evaporator, all connected in fluid communication using piping, valving and control systems such that the refrigerant and associated components of the heat transfer composition can flow through the system in known fashion to complete the refrigeration cycle. An exemplary schematic of such a basic system is illustrated in FIG. 3. In particular, the system schematically illustrated in FIG. 3 shows a compressor 10, which provides compressed refrigerant vapor to condenser 20. The compressed refrigerant vapor is condensed to produce a liquid refrigerant which is then directed to an expansion device 40 that produces refrigerant at reduced temperature and pressure, which in turn is then provided to evaporator 50. In evaporator 50 the liquid refrigerant absorbs heat from the body or fluid being cooled, thus producing a refrigerant vapor which is then provided to the suction line of the compressor.

Low-Temperature Systems and Methods

The heat transfer systems according to the present invention include low-temperature heat transfer systems that comprise a compressor, an evaporator, a condenser and an expansion device, in fluid communication with each other, a refrigerant of the invention, including each of Refrigerants 1-15, a lubricant, including a POE lubricant, a PVE lubricant or combinations of these.

The heat transfer methods according to the present invention include low-temperature heat transfer methods that include step of evaporating a refrigerant of the invention, including each of Refrigerants 1-15, in a temperature range of from about −45° C. to about ambient.

Cryogenic Systems and Methods

The heat transfer systems according to the present invention include cryogenic heat transfer systems that comprise a compressor, an evaporator, a condenser and an expansion device, in fluid communication with each other, a refrigerant of the invention, including each of Refrigerants 1-15, and a lubricant, including a POE lubricant, a PVE lubricant and combinations of these.

The heat transfer methods according to the present invention include cryogenic heat transfer methods that include step of evaporating a refrigerant of the invention, including each of Refrigerants 1-15, in a temperature of about −45° C. or less.

Exemplary Uses

In highly preferred uses of the present invention, the refrigerants of the present invention, including each of Refrigerants 1-15, are used as part of a process of and/or as part of a system for separating components, or at least portions of components, of a composition, particularly wherein such separation occurs at temperatures in the range of low-temperature refrigeration and/or cryogenic refrigeration. Non-limiting examples of such separation processes are disclosed in: U.S. Provisional Application 63/167,338, filed Mar. 29, 2021; U.S. Provisional Application 63/167,341, filed Mar. 29, 2021; and U.S. Provisional Application 63/167,341, filed Mar. 29, 2021, each of which is incorporated herein by reference.

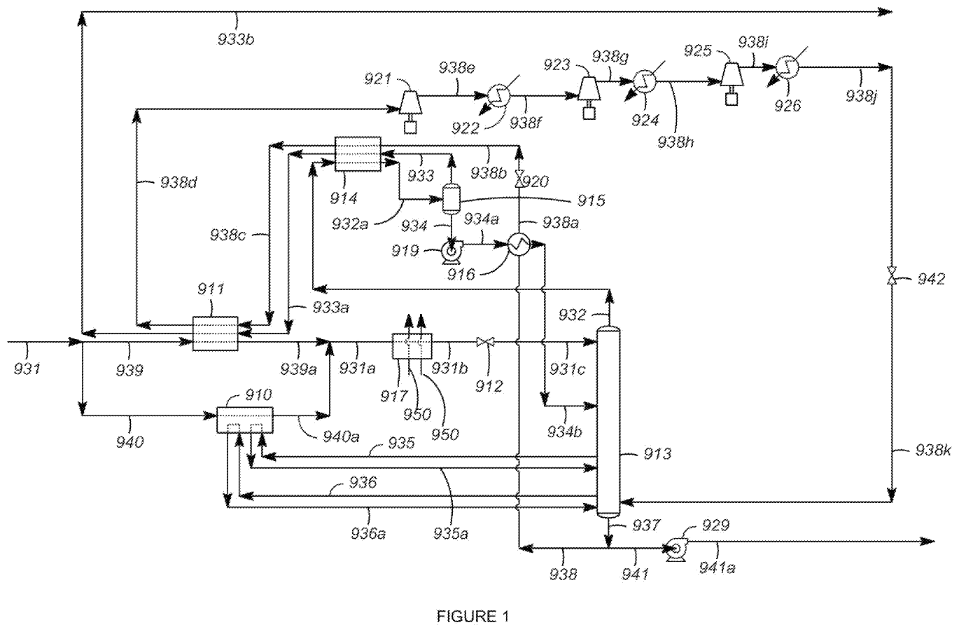

FIG. 1 is a process flow diagram showing a CO2 recovery system which removes carbon dioxide from hydrogen and lighter components from a synthetic gas stream 931 using a dual refrigerant CO2 fractionation process, as described for example in U.S. Provisional Application 63/167,341, filed Mar. 29, 2021. In this process, inlet gas enters the plant as feed stream 931. The feed stream 931 is usually dehydrated to prevent hydrate (ice) formation under cryogenic conditions. Solid and liquid desiccants have both been used for this purpose.

The feed stream 931 is split into two streams (stream 939 and 940). Stream 939 is cooled in heat exchanger 911 by heat exchange with cool carbon dioxide vapor (stream 938c) and cold residue gas (stream 933a). Stream 940 is cooled in heat exchanger 910 by heat exchange with column reboiler liquids (stream 936) and column side reboiler liquids (stream 935). The cooled streams from heat exchangers 910 and 911 are recombined into stream 931a.

Stream 931a is then further cooled with a refrigerant 950, preferably a refrigerant of the present invention, including each of Refrigerants 1-15, and the resultant stream (cooled stream 931b) is expanded to the operating pressure of fractionation tower 913 by expansion valve 912, cooling stream 931c before it is supplied to fractionation tower 913 at its top column feed point.

Overhead vapor stream 932 leaves fractionation tower 913 and is cooled and partially condensed in heat exchanger 914. The partially condensed stream 932a enters separator 915 where the vapor (cold residue gas stream 933) is separated from the condensed liquid stream 934. Condensed liquid stream 934 is pumped to slightly above the operating pressure of fractionation tower 913 by pump 919 before liquid stream 934a enters heat exchanger 916 and is heated and partially vaporized by heat exchange with carbon dioxide refrigerant from the bottom of the distillation column (described below). The partially vaporized stream 934b is thereafter supplied as feed to fractionation tower 913 at a mid-column feed point. A cold compressor (not shown) can be applied to overhead vapor stream 932 if higher pressure and/or lower carbon dioxide content is desired in the feed to the a pressure swing absorption (PSA) system. If a compressor is used on this stream, then the pump 919 can be eliminated, and the liquid from separator 915 would then be sent to fractionation tower 913 via a liquid level control valve.

Fractionation tower 913 is a conventional distillation column containing a plurality of vertically spaced trays, one or more packed beds, or some combination of trays and packing. It also includes reboilers (such as the reboiler and the side reboiler described previously) which heat and vaporize a portion of the liquids flowing down the column to provide the stripping vapors which flow up the column to strip the column bottom liquid product stream 937 of hydrogen and lighter components. The trays and/or packing provide the necessary contact between the stripping vapors rising upward and cold liquid falling downward, so that the column bottom liquid product stream 937 exits the bottom of the tower, based on reducing the hydrogen and lighter component concentration in the bottom product to make a very pure carbon dioxide product.

Column bottom liquid product stream 937 is predominantly liquid carbon dioxide. A small portion (stream 938) is subcooled in heat exchanger 916 by liquid stream 934a from separator 915 as described previously. The subcooled liquid (stream 938a) is expanded to lower pressure by expansion valve 920 and partially vaporized, further cooling stream 938b before it enters heat exchanger 914. Stream 938b functions as refrigerant in heat exchanger 914 to provide cooling of partially condensed stream 932a as described previously, with the resulting carbon dioxide vapor leaving as stream 938c.

The cool carbon dioxide vapor from heat exchanger 914 (stream 938c) is heated in heat exchanger 911 by heat exchange with the feed gas as described previously. The warm carbon dioxide vapor (stream 938d) is then compressed to a pressure above the pressure of fractionation tower 913 in three stages by compressors 921, 923, and 925, with cooling after each stage of compression by discharge coolers 922, 924, and 926. The compressed carbon dioxide stream (stream 938j) is then flash expanded through valve 942 and returned to a bottom feed location in fractionation tower 913. The recycled carbon dioxide (stream 938k) provides further heat duty and stripping gas in fractionation tower 913. The remaining portion (stream 941) of column bottom liquid product stream 937 is pumped to high pressure by pump 929 so that stream 941a forms a high pressure carbon dioxide stream which then flows to pipeline or reinjection. In certain instances, the carbon dioxide stream needs to be delivered as a sub-cooled liquid at lower pressure that can be transported in insulated shipping containers. For these cases, the carbon dioxide product (stream 941) is sub-cooled in heat exchanger 917 with refrigerant 950 before being let down to storage tank conditions. Therefore pump 929 is eliminated.

The cold residue gas stream 933 leaves separator 915 and provides additional cooling in heat exchanger 914. The warmed residue gas stream 933a is further heated after heat exchange with the feed gas in heat exchanger 911 as described previously. The warm residue gas stream 933b is then sent to the PSA system for further treating.

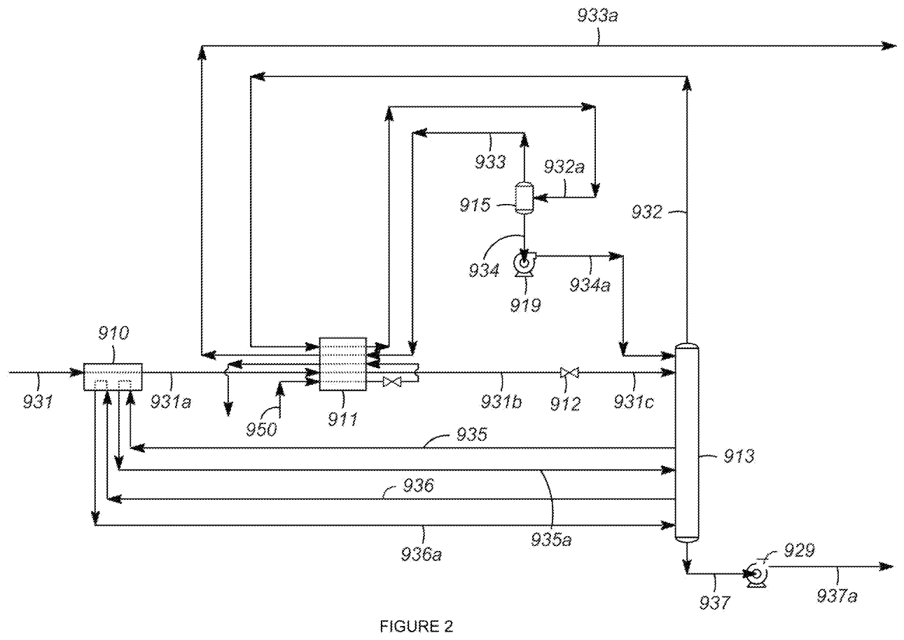

FIG. 2 is a process flow diagram showing the design of a processing unit to remove carbon dioxide from hydrogen and lighter components from a synthetic gas stream 931. The process involves the use of a mixed refrigerant CO2 fractionation process.

The feed stream 931 is usually dehydrated to prevent hydrate (ice) formation under cryogenic conditions. Solid and liquid desiccants have both been used for this purpose. The feed stream 931 is cooled in heat exchanger 910 by heat exchange with column reboiler liquids (stream 936) and column side reboiler liquids (stream 935). Stream 931a is further cooled in heat exchanger 911 by heat exchange with cold residue gas stream 933, and at least a first pass of a refrigerant 950 of the present invention, including a refrigerant according to each of Refrigerants 1-15. In preferred embodiments, the refrigerant 950 of the present invention makes a first pass through the heat exchanger 911 and then is flashed across an expansion valve to a lower pressure before making a second pass through the heat exchanger 911. The refrigerant of the present invention can provide a highly efficient cooling curve in heat exchanger 911 based on the inlet gas feed conditions. The further cooled stream 931b is expanded to the operating pressure of fractionation tower 913 by expansion valve 912, and sent to fractionation tower 913 at a mid-column feed point.

Overhead vapor stream 932 leaves fractionation tower 913 and is cooled and partially condensed in heat exchanger 911 with the mixed refrigerant stream. The partially condensed stream 932a enters separator 915 where the vapor (cold residue gas stream 933) is separated from the condensed liquid stream 934. Condensed liquid stream 934 is pumped to slightly above the operating pressure of fractionation tower 913 by pump 919 before liquid stream 934a is sent to fractionation tower 913 at the top feed point. A cold compressor (not shown) can be applied to overhead vapor stream 932 if higher pressure and/or lower carbon dioxide content is desired in the feed to the PSA system. If a compressor is used on this stream, then the pump 919 can be eliminated, and the liquid from separator 915 would then be sent to fractionation tower 913 via a liquid level control valve.

Fractionation tower 913 is a conventional distillation column containing a plurality of vertically spaced trays, one or more packed beds, or some combination of trays and packing. It also includes reboilers (such as the reboiler and the side reboiler described previously) which heat and vaporize a portion of the liquids flowing down the column to provide the stripping vapors which flow up the column to strip the column bottom liquid product stream 937 of hydrogen and lighter components. The trays and/or packing provide the necessary contact between the stripping vapors rising upward and cold liquid falling downward, so that the column bottom liquid product stream 937 exits the bottom of the tower, based on reducing the hydrogen and lighter component concentration in the bottom product to make a very pure carbon dioxide product.

Column bottom liquid product stream 937 is predominantly liquid carbon dioxide. Column bottom liquid product stream 937 is pumped to high pressure by pump 929 so that stream 937a forms a high pressure carbon dioxide stream which then flows to pipeline or reinjection. In certain instances, the carbon dioxide stream needs to be delivered as a sub-cooled liquid at lower pressure that can be transported in insulated shipping containers. For these cases, the carbon dioxide product in column bottom liquid product stream 937 is sub-cooled in heat exchanger 911 with mixed refrigerant 950 before being let down to storage tank conditions. Therefore pump 929 is eliminated.

The warm residue gas stream 933a leaves heat exchanger 911 after heat exchange with the feed gas as described previously. The warm residue gas stream 933a is then sent to the PSA system for further treating.

A preferred relationship between the equipment shown in FIG. 3 and the process flows illustrated in FIGS. 1 and 2 will now be described. With respect to FIG. 1, the evaporator 50 of the vapor compression system corresponds to the heat exchanger 917 where heat from the refrigerant of the present invention, including each of Refrigerants 1-15, provides cooling to process stream 931a as it is evaporated in the evaporator 50/911. With respect to each of FIG. 2, the evaporator 50 of the vapor compression system corresponds to the heat exchanger 911 where heat from the refrigerant of the present invention, including each of Refrigerants 1-15, provides cooling to process stream 931a as it is evaporated in the evaporator 50/911.

### Equipment for the Systems, Methods and Uses

Examples of commonly used compressors, for the purposes of this invention include reciprocating, rotary (including rolling piston and rotary vane), scroll, screw, and centrifugal compressors. Thus, the present invention provides each and any of the refrigerants, including each of Refrigerants 1-15, and/or heat transfer compositions as described herein, including those containing any one of Refrigerants 1-15, for use in a heat transfer system comprising a reciprocating, rotary (including rolling piston and rotary vane), scroll, screw, or centrifugal compressor.

Examples of commonly used expansion devices, for the purposes of this invention include a capillary tube, a fixed orifice, a thermal expansion valve and an electronic expansion valve. Thus, the present invention provides each and any of the refrigerants, including each of Refrigerants 1-15, and/or heat transfer compositions, including those containing any one of Refrigerants 1-15, as described herein for use in a heat transfer system comprising a capillary tube, a fixed orifice, a thermal expansion valve or an electronic expansion valve.

For the purposes of this invention, the evaporator and the condenser can each independently be selected from a finned tube heat exchanger, a microchannel heat exchanger, a shell and tube, a plate heat exchanger, and a tube-in-tube heat exchanger. Thus, the present invention provides each and any of the refrigerants and/or heat transfer compositions as described herein for use in a heat transfer system wherein the evaporator and condenser together form a finned tube heat exchanger, a microchannel heat exchanger, a shell and tube, a plate heat exchanger, or a tube-in-tube heat exchanger.

### EXAMPLES

The following examples are provided for the purpose of illustrating the present invention but without limiting the scope thereof.

### Comparative Example 1—Flammability

A refrigerant composition as indicated below which is not a refrigerant of the present invention is evaluated for purposes of comparison to refrigerant of the present invention:

TABLE CE1

| | CE1 |
|---|---|
| Component | Wt % |
| CO₂ | 50 |
| Propane | 36 |
| IsoPentane | 14 |
| Total | 100.0 |

A cylinder containing the refrigerant blend as identified above is allowed to slowly leak from the vapor valve until 20% of the contents are removed. This simulates a vapor leak from a refrigeration system. The liquid that remains in the cylinder is then expanded and found to have flame limits as determined according to ASTM-E681 at 23 C, which means the remaining contents of the cylinder are flammable.

### Example 1—Flammability

A refrigerant composition of the present invention, as shown in Table 1 below, is evaluated:

TABLE E1

| | E1 |
|---|---|
| Component | Wt % |
| CO₂ | 54 |
| 1234ze (E) | 38 |
| 1233zd(E) | 18 |
| Total | 100.0 |
| GWP | 1 |

The process of Comparative Example 1 is repeated with the refrigerant of Table E1, that is, a cylinder containing the refrigerant blend as identified above is allowed to slowly leak from the vapor valve until 20% of the contents are removed. This simulates a vapor leak from a refrigeration system. The liquid that remains in the cylinder is then expanded and found to not have flame limits as determined according to ASTM-E681 at 23° C., which means the remaining contents of the cylinder are nonflammable, which means the blend of Table E1 would be Class A1.

### Example 2: Low-Temperature Refrigeration Application—Performance

Due to certain characteristics of refrigeration systems, including particularly low temperature refrigeration systems, it is important in certain embodiments that such systems are capable of exhibiting adequate performance parameters system with respect to previously used refrigerants in low-temperature systems.

A first system of the type as disclosed in U.S. Provisional Application 63/167,338, filed Mar. 29, 2021, is operated in a dual refrigerant process as illustrated in FIG. 1 and described above with the refrigerant as disclosed in Table CE1 and with a refrigerant of the present invention as disclosed in Table E1. In both cases the process stream enters the evaporator 917/50 and the refrigerant of the present invention (Refrigerant E1) evaporates. Operation of the system using the refrigerant of the present invention (Refrigerant E1) provides a decrease in power consumption of at least about a 3%, or at least about 4%, and a better match to the cooling curve, compared to the prior refrigerant of Table CE1 above. The refrigerant cooling curve match indicates that the refrigerant of the present invention is changing temperature at near the same rate that the process stream that is being cooled is changing temperature. A better match in the cooling curve would lead to more efficient cooling of the process stream.

A second system of the type as disclosed in U.S. Provisional Application 63/167,338, filed Mar. 29, 2021, is operated in mixed refrigerant process as illustrated in FIG. 2 and described above with the refrigerant as disclosed in Table CE1 and with a refrigerant of the present invention as disclosed in Table E1. In both cases the process stream enters the evaporator 911/50 and the refrigerant of the present invention (Refrigerant E1) evaporates. Operation of the system using the refrigerant of the present invention (Refrigerant E1) provides a decrease in power consumption of at least about a 3%, or at least about 4%, and a better match to the cooling curve compared to the prior refrigerant of Table CE1 above. The better cooling curve match indicates that the refrigerant of the present invention is changing temperature at near the same rate that the process stream that is being cooled is changing temperature. A better match in the cooling curve would lead to more efficient cooling of the process stream.

### Example 3: Low-Temperature Refrigeration Application—Performance

Due to certain characteristics of refrigeration systems, including particularly low temperature refrigeration systems, it is important in certain embodiments that such systems are capable of exhibiting adequate performance parameters system with respect to previously used refrigerants in low-temperature systems. Such operating parameters include:
Capacity of at least 90%, and even more preferably greater than 95% of the capacity of the system operating with the prior refrigerant. This parameter allows the use of existing compressors and components designed for the use of the prior refrigerant.
Equal or better efficiency than the prior refrigerant, leading to energy savings with new mixture.
Equal or lower energy consumption
   Low temperature refrigeration systems can be used, for example, in an air-to-fluid evaporator (where the fluid is being cooled), a reciprocating, scroll or screw compressor, an air-to-refrigerant condenser to exchange heat with the ambient air, and a thermal or electronic expansion valve.

This example illustrates the COP and capacity performance of the Table E1 composition compared to a typical prior refrigerant used in low temperature systems, namely, R410A in a low-temperature refrigeration system. The low temperature refrigeration system of this example is tested using the refrigerant of Table E1 and the performance results are in Table E3 below compared to operation with R410A. Operating conditions were: Condensing temperature=40.6° C.; Condenser sub-cooling=1° C.; Evaporating temperature=−31.6° C.; Degree of superheat at evaporator outlet=5.5° C.; Isentropic Efficiency=70%; Volumetric Efficiency=100%; Degree of superheat in the suction line=30.6° C.

TABLE E3
Performance in Low Temperature Refrigeration System

| | | | Pressure | Discharge |
|---|---|---|---|---|
| | Capacity | Efficiency | ratio | Pressure |
| Refrigerant | (% R410A) | (% R410A) | (% R410A) | (% R410A) |
| R410A | 100% | 100% | 100% | 100% |
| E1 | =>95% | =>95% | =<105% | 95-105% |

As shown above in Table E3, the thermodynamic performance of a low temperature refrigeration system using a refrigerant of the present invention is excellent compared to performance of R410A in the system, having a capacity and efficiency that is 95% or greater compared to the values when R410A is operated in the system.

What is claimed is:

1. A refrigerant comprising at least about 98.5% by weight of the following three compounds, with each compound being present in the following relative percentages:
about 40% to about 60% by weight carbon dioxide (CO2);
about 30% to about 45% by weight of trans-1,3,3,3-tetrafluoropropene (HFO-1234ze(E)); and
2.0% to about 15% by weight of trans-1-chloro-3,3,3-trifluoropropene (HFCO-1233zd(E)).

2. The refrigerant of claim 1 comprising the following three compounds in the following relative percentages:
about 50% to about 60% by weight CO₂;
about 35% to about 45% by weight of HFO-1234ze(E); and
about 5% to about 10% by weight of HFCO-1233zd(E).

3. The refrigerant of claim 1 comprising the following three compounds in the following relative percentages:
about 50% to about 55% by weight CO₂;
about 35% to about 40% by weight of HFO-1234ze(E); and
about 5% to about 10% by weight of HFCO-1233zd(E).

4. The refrigerant of claim 1 comprising the following three compounds in the following relative percentages:
about 54% by weight CO₂;
about 38% by weight of HFO-1234ze(E); and
about 8% by weight of HFCO-1233zd(E).

5. The refrigerant of claim 1 comprising the following three compounds in the following relative percentages:
54%+/−1% by weight CO₂;
38%+/−1% by weight of HFO-1234ze(E); and
8%+/−1% by weight of HFCO-1233zd(E).

6. The refrigerant of any claim 1 consisting of CO₂, HFO-1234ze(E); and HFCO-1233zd(E).

7. A low temperature refrigeration system comprising a refrigerant of claim 1.

8. A cryogenic refrigeration system comprising a refrigerant of claim 1.

9. A method cooling comprising evaporating a refrigerant of claim 1.

10. A method of cooling using a system of claim 8.

11. A method of separating components contained in a process stream by cooling a process stream using a refrigerant of claim 1.

12. A method of separating components contained in a process stream by cooling a process stream using a system of claim 8.

13. A method of separating components contained in a process stream comprising the method of claim 10.

14. A method according to claim 13 wherein the process stream comprises a synthetic gas stream or a portion thereof.

15. The method of claim 14 wherein said process stream comprises at least hydrogen and CO₂.

16. The method of claim 14 wherein said separating step comprises separating hydrogen from CO₂.

17. A refrigerant consisting essentially of:
about 40% to about 60% by weight carbon dioxide (CO₂);
about 30% to about 45% by weight of trans-1,3,3,3-tetrafluoropropene (HFO-1234ze(E)); and
2.0% to about 15% by weight of trans-1-chloro-3,3,3-trifluoropropene (HFCO-1233zd(E)).

18. A cryogenic refrigeration system comprising the refrigerant of claim 17.

19. A method of separating components contained in a process stream by cooling a process stream using a refrigerant of claim 17.

20. A refrigerant consisting essentially of:
54%+/−1% by weight CO₂;
38%+/−1% by weight of HFO-1234ze(E); and
8%+/−1% by weight of HFCO-1233zd(E).
